(19) United States
(12) Patent Application Publication
(10) Pub. No.: US 2011/0027448 A1
(43) Pub. Date: Feb. 3, 2011

(54) Coffee or Mocha Flavored Additive for Bakery Purposes

(76) Inventor: Van Miller, Norval (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/847,611

(22) Filed: Jul. 30, 2010

Related U.S. Application Data
(60) Provisional application No. 61/230,146, filed on Jul. 31, 2009.

(51) Int. Cl. A23L 1/221; A23G 9/32

(52) U.S. Cl. 426/565; 426/613

(57) ABSTRACT

An anhydrous fat-based discrete flavoring additive is provided for incorporation into baked goods. The discrete flavoring additive product comprises from substantially 0% to 2% by weight of moisture, from about 3% to about 30% by weight of a finely ground natural flavoring agent comprising coffee and optionally cocoa, from about 25% to about 35% by weight of a bakery-compatible oil that is substantially liquid at about 35 degrees C. to about 40 degrees C., with the balance being sugar. The bakery-compatible oil is selected from the group consisting of vegetable oils, cocoa butter, liquid butter fats etc., and mixtures thereof, which exhibit a solid fat index curve characteristic which is preferably similar to that of cocoa butter. The bakery-compatible oil or fat system has finely ground coffee, optionally cocoa or other optional flavoring agents, held in suspension. This suspension is mixed with sugar, and is then cooled to effect solidification. The product, when solidified, will remain substantially solidified at temperatures below about 35 degrees C., and particularly at room temperature of about 20 degrees C., and forms a discrete final product which can be used as a coffee or mocha-flavored additive in the production of bakery goods.

### RELATED APPLICATIONS

This application claims the benefits of priority under 35 U.S.C. §119(e) to U.S. Provisional Application Ser. No. 61/230,146, filed Jul. 31, 2009, the entirety of which is hereby incorporated by reference.

### FIELD OF THE INVENTION

This invention relates to anhydrous fat-based flavoring additives primarily intended for incorporation into baked goods. Specifically, the present invention is directed to discrete flavoring additive products that may be provided in the form of molded products, flakes, chips, chunks, or the like, which are flavored with coffee, and other optional additional flavors and sugar, that are carried in a bakery-compatible fat system which is substantially solid at room temperatures. The fat-based flavoring additive of the present invention has a distinctive coffee, or alternatively a mocha flavor, and preferably, the additive has a mouth-sense that provides a crunch or crispness, when consumed.

As such, a coffee or mocha-flavored molded product, flake, chip or chunk is provided, which can be incorporated into, or on top of, bakery items such as cookies, cakes, muffins, biscuits, donuts, or the like. However, the additive might also be incorporated into or on to, ice cream products, such as ice cream sundaes, or the like.

Typically, though, the additives of the present invention are used in the production of food items such as cookies, that are produced in a bakery environment, and that are later consumed as is, or consumed by simply removing the individual food item from its protective wrapping or packaging.

### BACKGROUND OF THE INVENTION

It has often been attempted throughout the baking industry to provide baked goods and flour confections that may have coffee or mocha flavoring therein. This is usually achieved simply by the introduction of coffee, mocha, or other such flavoring elements directly into the other ingredients during preparation. For example, coffee flavouring can be added as powdered coffee, powdered instant coffee, or the like, by mixing the coffee product into the remaining ingredients, such as butter and/or sugar and/or oils. Mocha flavoring is typically achieved by adding chocolate (either as chips, chunks or flakes, or as chocolate mixed into the other ingredients), to a system comprising coffee flavoring.

However, the baking and flour confection industry and the market that it serves are always looking for ways to improve their products, and to introduce new products having specific flavors but differing presentation and/or mouth-sense. One specific requirement that has so far not been met has been the requirement to provide specific coffee or mocha-flavored additives for incorporation into, or on top of, baked goods and flour confections. In particular, the prior art has not provided a system wherein the coffee or mocha flavored additive has a discrete presence in the baked good when it is consumed.

In contrast, it has been known for many years to provide such discrete flavoring additives as chocolate chunks, peanut butter chips, butterscotch chips, cinnamon chunks, and the like, for baked goods and flour confections. However, heretofore, it has not been possible to provide such molded products, chips, chunks, or flakes for use in bakery products, which have a good coffee or mocha flavor release.

This is desirable since it is sometimes desired to have a product with this flavour release that still has a mouth-sense, or crunch, such as that which might be found in a similar chocolate formulation.

Unexpectedly, the present inventor has discovered that by providing a fat-based carrier system that is substantially anhydrous and which comprises a bakery-compatible oil which preferably exhibits substantially the same or similar solid fat index (SFI) curve characteristics as those of cocoa butter—so that it is substantially solid at room temperature—then ground coffee, cocoa, or the like, and sugar may be properly incorporated into the fat system in appropriate proportions so as to produce a food additive that can be used as a flavoring additive in baked goods, other flour-based confections, or similar products. The resultant additive product, which may take the form of a molded product, or a flake, chip or chunk (as those terms are used in the baking industry), will maintain its integrity as a discrete flavoring additive during the baking process, and further, when the resultant product is consumed, it will exhibit the desired mouth-sense whereby the molded product, flake, chip or chunk will have a chocolate-like crunch when it is bitten.

### PRIOR ART

One prior flavoring additive is that taught in FEHR et al U.S. Pat. No. 3,582,353 issued Jun. 1, 1971. There, a flavored and/or colored shortening material of hard fat having a sharp melting point is used, and distributed into the bakery mix. What results is distributed localized areas throughout the baked product, when it has been baked, that have a particular mouth sensation similar to that of butter. The flavoring materials may include spices, simulated meat, fruit, fowl, or vegetable flavors, or other dairy flavors, as well as organic acids to provide sour flavors and the like. The resulting baked product is reported to have identifiable localized areas of the colored and/or flavored flakes in spots throughout the baked product, that have a discernable taste. It must be noted, however, that the FEHR et al patent describes only localized areas of concentrated flavor where the flavor is not necessarily a true or real flavor, and particularly which might be specifically of a gummy texture and/or caramelized flavor. Moreover, the FEHR et al product is essentially fat, having very little solid constituent present, and not being capable of providing a mouth-sense which includes a chocolate-like crunch, as in the case of the present invention.

Further, in my earlier patent, namely U.S. Pat. No. 5,447,735, a flavoring system for providing cinnamon flavoring is provided which is similar to the present invention. However, mechanisms to provide coffee or mocha-flavored molded products, flakes, chips and chunks, are not described therein, and the use of granulated sugar is required. As such, a modified formulation is required.

### SUMMARY OF THE INVENTION

Accordingly, it is a principal advantage of the present invention to provide a coffee or mocha-flavored molded product, flake, chip or chunk, for use in the preparation of a bakery item. This advantage, as set out hereinabove, as well as other advantages, objects and goals inherent thereto, are at least partially or fully provided by the present invention, as set out herein below.

Accordingly, in a first aspect, the present invention provides an edible, coffee or mocha, preferably anhydrous, fat-based flavored food additive in the form of a molded product, flake, chip of chunk; wherein said flavored food additive is intended for incorporation into baked goods or for use in snack items, and comprises from substantially 0% to 5% by weight, and more preferably from 0.1 to 2%, of moisture, from about 2% to about 35% by weight of a finely ground natural flavoring agent comprising coffee and optionally cocoa, from about 25% to about 35% by weight of a bakery-compatible oil that is substantially liquid at about 35 degrees C. to about 40 degrees C., with the balance being sugar.

Preferably, the bakery-compatible oil is a fat or oil that exhibits a solid fat index (SFI) curve characteristic having defined ranges of solid fat and liquid fat components at defined temperatures. One suitable example would be as follows:
10.0 degrees C.—43-66% solid fats, balance liquid fats
21.1 degrees C.—32-52% solid fats, balance liquid fats
26.6 degrees C.—20-44% solid fats, balance liquid fats
33.3 degrees C.—6-25% solid fats, balance liquid fats, and
40.0 degrees C.—0-5% solid fats, balance liquid fats.

Also, the bakery-compatible oil is preferably selected from the group consisting of vegetable oils, cocoa butter, and liquid butter fats, and mixtures thereof, which preferably exhibit the said solid fat index curve characteristic.

Still further, the bakery-compatible oil is preferably one that solidifies at temperatures of about 6 degrees C. to about 12 degrees C. and remains substantially solidified at temperatures below about 35 degrees C.

### DETAILED DESCRIPTION OF THE INVENTION

It will be understood, for purposes of this discussion, that use of the words “flakes”, “chips”, “chunk” or the like, are to be interpreted in the manner that those terms are used in the bakery industry. For example, “flakes” implies that the manufactured fat-based discrete flavoring additive product has a relatively small thickness compared to its length or breadth. A “chunk” is typically interpreted as having a relatively large thickness compared to its length and breadth. In general, neither flakes or chunks are molded; rather, they are typically manufactured from a semi-liquified layer of mixed ingredients that will flow, and which are placed on a moving belt and passed through a cooling tunnel to solidify. The solidified material can then be broken into flakes or chunks.

A chip product may also be produced methods known to those skilled in the art, such as by extrusion of a semi-liquified material into a desired, typically, tear-dropped shape.

Still further, the flavored food additive may be molded to a specific shape or size, by solidification of product within a suitably shaped mold. One particularly desired shape of the food additive of the present invention is to provide a product that has been molded into the shape of a coffee bean. The size of the “coffee bean” can be adjusted to be suitable for its intended application. Thus, a coffee bean shaped product, as well as the flakes, chips, and chunks of the discrete food additive, can be any suitable size for incorporation into the bakery product.

Preferably though, the flavored food additive of the present invention, has a size between 3 to 30 mm, and more preferably, between 5 and 15 mm.

The food additive is preferred used so that it is incorporated into, or on top of, bakery items such as cookies, cakes, muffins, biscuits, donuts, or the like. Other bakery items, can include items such as tea biscuits, arrowroot, bran filled digestive biscuits, graham wafers, and the like. Further, the additive might also be incorporated into or on to, non-bakery food items, such as for example, ice cream products, including ice cream, ice cream sundaes, ice cream cones, or the like. As such, the flavored additive of the present invention can be used in the production of a wide variety of different foods.

The skilled artisan will, however, also be aware that the food additive of the present invention might be consumed as is, or optionally provided in slightly larger format for use as a snack item. For these snack item applications, the size of the flavored food additive be increased to between 10 and 40 mm. However, this is not the primary intended use of the flavored additive of the present invention.

A most important goal of the present invention, however, is to provide a discrete flavored, food additive, so that coffee (or mocha, or other additional natural flavoring ingredients), may be carried into a baked product while being suspended in a bakery-compatible fat which provides the desired mouth-sense and feel.

In keeping with the present invention, the fat-based, discrete flavoring additive, or the snack item, is preferably substantially anhydrous, in that it is has from substantially 0% to about 5%, and more preferably from 0.1% to 2%, by weight of moisture therein.

The discrete flavoring flake, chip or chunk, or molded product, that is made in keeping with the present invention will have from about 2% to about 35% by weight of finely ground coffee and optionally cocoa, together with from about 25% to about 35% by weight of a bakery-compatible oil, with the balance being sugar.

The coffee level is preferably between 2 and 20% by weight of the total formulation, and more preferably, between 3 and 12%. The coffee is preferably a naturally occurring coffee bean or powder that has been finely ground, in keeping with well known procedures therefor.

Cocoa is preferably added as a optional coloring agent and/or as a flavoring agent. The preferred level of cocoa is between 0 and 18%, and more preferably, between 5 and 15%, by weight. A naturally occurring, finely ground, powdered cocoa material which is produced in keeping with known procedures therefor, is preferred.

In general, at lower levels, the cocoa primarily acts as a coloring agent to provide a dark, richer looking discrete additive. At higher levels, the flavor of the cocoa is more pronounced, and the combined coffee and cocoa flavoring produces a “mocha” flavoring. At still higher levels, the cocoa flavor can begin to mask the coffee flavor.

Any suitable type of coffee or cocoa might be used, depending on taste considerations, pricing, and availability.

Likewise, other natural flavoring ingredients that are compatible with the system of the present invention might also be added. Specifically, the present invention contemplates that other natural flavoring agents would also be preferably finely ground so as to be suspended in the fat system, together with the coffee, cocoa or sugar. These additional flavoring ingredients can include materials such as, for example, ginger, nutmeg, cloves, allspice, maple sugar (or dehydrated maple syrup), or mixtures thereof.

As to the sugar component, it is a preferably a finely ground sugar. Thus, confectioner's sugar or powdered sugar is preferred in order to produce a flavored additive of the present invention, which has a good mouth-sense, and which is not coarse or un-refined.

Optionally, granulated sugar can be added in the final stages of production, to provide modifications to the look and mouth-sense of the final product. Typically, the level of granulated sugar is less than 25% of the total added sugar, and more preferably, less than 10% of the total added sugar.

The fat (or oil) component is preferably a homogenous mixture of oils in any desired proportion of vegetable oils, cocoa butter, and liquid butter fats ranging from substantially 0% to substantially 100%, and mixtures thereof. It is to be noted that the finely ground coffee, cocoa or other optional flavoring ingredients, as well as the fine sugar components, are preferably added to the fat system so that the powdered products are held in suspension in the fat system. As such, when the fat component is liquid, then the coffee, cocoa and/or sugar are held in suspension; and when the fat system solidifies, the coffee and cocoa are still held in suspension but in much more immobile fashion since at lower temperatures there is substantially little liquid fat component.

The bakery-compatible oil is such that it is preferably substantially liquid at elevated temperatures of about 35 degrees C. to about 40 degrees C. Preferably, the bakery-compatible oil may be a suitable vegetable oil, cocoa butter, liquid butter fat, or other liquid dairy fat, and mixtures thereof, which are liquid or liquefiable, during the manufacturing stage. In any event, the bakery-compatible oil will exhibit generally similar solid fat index and melting points as those of cocoa butter, as described in greater detail hereafter. Moreover, the bakery-compatible oil must be such that it may be miscible with liquid cocoa butter at temperatures of about 35 degrees C. to about 50 degrees C., so that if they are mixed they will make a substantially homogenous mixture. Moreover, any bakery-compatible oil or mixtures thereof with liquid dairy fat will preferably be such that it will crystallize in much the same manner as chocolate when found in chocolate-compatible fats, so that when solid the product will offer a snap in much the same way that chocolate will snap if it is broken. As such, the food additive of the present invention, will preferably have a chocolate-like texture when consumed.

Moreover, as noted above, the characteristic SFI curves which describe the solid fat index and melting points of the bakery-compatible oils, cocoa butter, and/or butter fat, should be substantially similar to each other, and thus they will exhibit the characteristic that they are sufficiently stable at about room temperature of about 20 degrees C. so that the oils will not smear during mixing with other prescribed ingredients of the baked or other goods being made, prior to those goods being baked or otherwise prepared.

Additionally, however, the bakery-compatible fats or oils used should remain substantially solidified and relatively firm during the baking process. Further, though, the bakery-compatible oils used in the fat system of the present invention are preferably such that they will commence to melt in the mouth at approximately 35 degree C.; and of course, the oils or fats used in the fat system of the present invention must not otherwise conflict with, or be intolerable with the intended baked goods, flour confections, snack items, or other food products into which they will be incorporated.

Of course, it is also true that the oils or fats and other ingredients used in preparation of the discrete flavoring additives, or snack items, of the present invention must be compatible with requirements for controlled ingredient regulations, legends and other labeling provisions that are imposed on food products. Preferably, the oils or fats used herein, therefore, are vegetable-based oils and fats, and preferably are oils or fats which are free of trans fats. Suitable oils can include cocoa butter, fractionated palm kernel oil, or the like, but other oils will be known to the skilled artisan.

The preferred bakery-compatible oils used in the present invention are preferably miscible with liquid cocoa butter in any proportion, at temperatures of about 35 degrees C. to about 50 degrees C. Thus, if they are mixed together, they will make a substantially homogenous mixture. If so, then they will solidify or crystallize at lower temperatures as an homogenous mixture. The following table provides a typical solid fat index (SFI) curve range for suitable vegetable oils, liquid butter fats, and mixtures thereof, which characteristics are essentially those of cocoa butter or butter fat, and which in any event can be generally described, as follows:

### Typical Solid Fat Index (SFI) Curve

| | |
|---|---|
| 10.0 degrees C. | 43-66% solid fats, balance liquid fats |
| 21.1 degrees C. | 32-52% solid fats, balance liquid fats |
| 26.6 degrees C. | 20-44% solid fats, balance liquid fats |
| 33.3 degrees C. | 6-25% solid fats, balance liquid fats |
| 40.0 degrees C. | 0-5% solid fats, balance liquid fats |

It may be that, in order to achieve the solid fat index curve characteristics set forth in the table above, it will be necessary to process the solid fats of the vegetable oils being used by blending or processing them, but only to the extent necessary so as to obtain the solid fat index curve having the defined ranges of solid and liquid components at the defined temperatures. Moreover, so as to generally exhibit a snap when broken, the solidified fats will usually be more to the solid limits within the above table. Thus, so-called “hard butter”—vegetable oils and mixtures thereof showing butter fat solid fat index curve characteristics at the more solid end of the ranges of the above table—or the like, are particularly useful for purposes of the present invention.

From the above, it is clear that the oils and/or liquid fats being used are preferably substantially in a liquid phase above about 35 degrees C. to about 40 degrees C., and are miscible as liquids, and that they are substantially solidified at least at about 6 degrees C. to about 12 degrees C. Moreover, once solidified, they will remain firm and will show no tendency to smear at about room temperature of 20 degrees C.

As such, it is preferred that the additive, and more particularly, the bakery-compatible oil exhibits the characteristic that it is stable at about room temperature so as not to smear during mixing with the other prescribed ingredients of the baked goods into which said discrete flavoring additive is being incorporated, prior to baking the baked goods.

The bakery-compatible oil, when liquid, might be mixed with liquid butter fat. Regardless, though, the bakery-compatible oil will preferably exhibit substantially identical solid fat index curve characteristics as those of cocoa butter or butter fat. What that means is that the fat ingredients of the present invention will exhibit solid, melting, and liquid characteristics similar to those of cocoa butter or butter fat whether or not cocoa butter or butter fat is, indeed, included in the homogenous mix of bakery-compatible oils. Therefore, certain dietary and/or religious requirements which preclude the actual use of butter, for example, in certain food items which may be consumed at particular times, can be fully satisfied by the fat-based flavoring products, flakes, chips or chunks of the present invention.

Because of the fat system incorporated into fat-based discrete flavoring additives of the present invention, the flakes, chips, chunks or molded products, provided by this invention may be incorporated into baked products, in such a manner that products such as tea biscuits, cookies or muffins which may have a relatively fast baking time—for example, ten or fifteen minutes—at baking temperatures of about 177 degrees C. may be made; while other discrete flakes, chips, chunks or molded products, according to the present invention may be baked into breads or other confections that might have baking times of thirty to forty minutes at temperatures above 177 degrees C.

Preferably, therefore, the bakery-compatible oil exhibits the characteristic that it has slow flow rates so as to stay substantially firm during a baking process at temperatures of from about 170 degrees C. up to about 200 degrees C., for periods of from about 5 minutes up to about 45 minutes.

The skilled artisan will also be aware, though, that when used in colder applications, such as ice cream formulations, the types of oils and fats can be adjusted so as to provide a fat component having an SFI curve characteristics more suitable for lower temperature applications. One suitable SFI curve for lower temperature applications would be as follows:

| | |
|---|---|
| 10° C. | 40 ± 5% solid fats, balance liquid fats |
| 23.1° C. | 15 ± 5% solid fats, balance liquid fats |
| 28.9° C. | 9 ± 3% solid fats, balance liquid fats |
| 32.3° C. | 3 ± 1% solid fats, balance liquid fats |
| 40° C. | 0% solid fats, balance liquid fats. |

However, the skilled artisan would be aware that other SFI curves could also be suitable.

Optionally, the flavored flakes, chips, chunks or molded products of the present invention, can additionally comprise a dairy component. As such, the chips, chunks, flakes or molded products can comprise milk or cream solids in the amount of about 0 to 15%, by weight of the total additive formula, more preferably between 3 to 12%, and most preferably, between 4 to 10%, by total formula weight. The milk or cream solids are preferably added as powdered milk or cream. If the optional dairy component is also added, however, the amount of cocoa is preferably reduced to a range of from 1 to 10%, by weight of the formulation, or more preferably, to a range of from 2 to 8%, by total additive formula weight.

The level of milk or cream solids added can also be adjusted to provide a desired flavoring effect, such as for example, providing a milk and coffee flavoring, or a coffee and cream combination. This taste can be adjusted to suit any particular preference by the user.

As for the snack food item possibility, the snack food item provided by the present invention would employ essentially the same fat system as that described hereinabove, which is flavored with coffee, sugar, optionally cocoa (for coloring, or to obtain a mocha flavoring), optionally milk or cream solids, and other additional flavorings, in accordance with the flavored food additive formulations provided hereinabove.

Turning now to the process by which the anhydrous fat-based discrete flavoring additives of the present invention are manufactured, the process preferably utilizes techniques already known within the art. One possible production method is similar to the production process used in the production of the cinnamon-flavored food additive which is described in U.S. Pat. No. 6,368,655 (the contents of which are incorporated herein by reference). As such, one example of a suitable production process would typically comprise the following steps, namely:

(a) mixing the bakery-compatible oil with finely ground coffee and optionally cocoa in a mixer at a temperature of about 35 degrees C. to about 50 degrees C., so as to obtain an homogenous mixture having the coffee (and cocoa) suspended therein;

(b) transferring the homogenous mixture to a holding tank, and maintaining the temperature of the homogenous mixture at about 39 degrees C. to about 45 degrees C.;

(c) continuously agitating the homogenous mixture while it is in the holding tank;

(d) pumping the homogenous mixture to a tempering unit, continuously agitating the homogenous mixture while in the tempering unit, and slightly cooling the homogenous mixture to about 29 degrees C. to about 34 degrees C.;

(e) transferring the slightly cooled homogenous mixture to a further mixing tank, and mixing sugar therewith;

(f) transferring the resultant sugar, coffee, oil and optionally cocoa mixture to a further discrete particle manufacturing means so as to produce discrete flakes, chips, chunks or molded products, from that resultant mixture;

(g) cooling the discrete flakes, chips, chunks or molded products to a temperature of from about 6 degrees C. to about 12 degrees C.; and

(h) finally, removing the cooled discrete flakes, chips, chunks or molded products for further handling and/or storage and/or shipping.

The resultant flakes, chips, chunks or molded products, are ready to be incorporated into, or on to, a variety of goods, but most notably into or on to, baked products such as cookies, cakes, muffins, or the like, as previously mentioned.

Additional details of the food additive production technique, however, are outside of the scope of this invention, and will not be described in any further detail.

There has therefore been described an anhydrous fat-based discrete flavoring additive in which coffee, optionally cocoa, fats or oil, and sugar are provided as discrete flakes, chips or chunks for incorporation into baked goods, flour confections, ice cream products, or the like. The discrete flavoring additive is such that it will retain its integrity as a flake, chip, chunk or molded product, even when it is incorporated into baked goods, and will provide a chocolate-like mouth-sense, together with a distinct coffee (or mocha or cocoa) flavor. As noted, other flavoring ingredients that are compatible with the system of the present invention, might also be included.

Further, there has also been described a snack item which can be consumed as is, which gives a pleasant chocolate-like mouth sensation, together with a distinct coffee (or mocha or cocoa) flavor.

Accordingly, it is apparent that there has been provided, in accordance with the present invention, a discrete coffee or mocha-flavored food additive, such as, or flake, chip, chunk, or a molded product, which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practiced in the absence of any element which is not specifically disclosed herein. Moreover, unless otherwise specifically noted, all of the features described herein may be combined with any of the above aspects, in any combination.

Further, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

1. A discrete, edible fat-based flavored food additive which may be molded in a mold, formed into chips, or spread onto a belt for manufacture into flake or chunk products; wherein said flavored food additive is intended for incorporation into baked goods or for use in snack items, and comprises from substantially 0% to 5% by weight of moisture, from about 2% to about 35% by weight of a finely ground natural flavoring agent comprising coffee and optionally cocoa, from about 25% to about 35% by weight of a bakery-compatible oil that is substantially liquid at about 35 degrees C. to about 40 degrees C., with the balance being sugar.

2. A discrete, edible fat-based flavored food additive as claimed in claim 1 wherein the level of coffee is between 2 and 20% by weight, and the level of cocoa is between 0 and 18%, by weight.

3. A discrete, edible fat-based flavored food additive as claimed in claim 1 wherein the level of coffee is between 3 and 12% by weight, and the level of cocoa is between 5 and 15%, by weight.

4. A discrete, edible fat-based flavored food additive as claimed in claim 1 wherein said bakery-compatible oil is selected from the group consisting of vegetable oils, cocoa butter, and liquid butter fats, and mixtures thereof.

5. A discrete, edible fat-based flavored food additive as claimed in claim 4 wherein said bakery-compatible oil exhibits the following SFI (solid fat index) curve characteristics, namely:
10.0 degrees C.—43-66% solid fats, balance liquid fats
21.1 degrees C.—32-52% solid fats, balance liquid fats
26.6 degrees C.—20-44% solid fats, balance liquid fats
33.3 degrees C.—6-25% solid fats, balance liquid fats
40.0 degrees C.—0-5% solid fats, balance liquid fats.

6. A discrete, edible fat-based flavored food additive as claimed in claim 1, wherein said bakery-compatible oil solidifies at about 6 degrees C. to about 12 degrees C. and remains substantially solidified at temperatures below about 35 degrees C.

7. A discrete, edible fat-based flavored food additive as claimed in claim 1, wherein said bakery-compatible oil exhibits the characteristic that it is stable at about room temperature so as not to smear during mixing with the other prescribed ingredients of said baked goods into which said discrete flavoring additive is being incorporated, prior to baking said baked goods.

8. A discrete, edible fat-based flavored food additive as claimed in claim 1, wherein said bakery-compatible oil exhibits the characteristic that it has slow flow rates so as to stay substantially firm during a baking process at temperatures of from about 170 degrees C. up to about 200 degrees C., for periods of from about 5 minutes up to about 45 minutes.

9. A discrete, edible fat-based flavored food additive as claimed in claim 1, wherein said bakery-compatible oil exhibits the characteristic that it has slow flow rates so as to stay substantially firm during a bakery proofing process at temperatures of from about 40 degrees C. up to about 60 degrees C., for periods of from a few minutes up to about a few hours.

10. A discrete, edible fat-based flavored food additive as claimed in claim 1 wherein the level of moisture is between 0.1% to 2%, by weight.

11. A discrete, edible fat-based flavored food additive as claimed in claim 1 suitable for use in colder applications, wherein said bakery-compatible oil exhibits an SFI curve characteristic, as follows:

| | |
|---|---|
| 10° C. | 40 ± 5% solid fats, balance liquid fats |
| 23.1° C. | 15 ± 5% solid fats, balance liquid fats |
| 28.9° C. | 9 ± 3% solid fats, balance liquid fats |
| 32.3° C. | 3 ± 1% solid fats, balance liquid fats |
| 40° C. | 0% solid fats, balance liquid fats. |

12. A discrete, edible fat-based flavored food additive as claimed in claim 1 additionally comprising milk or cream solids in the amount of about 0 to 15%, by weight of the total additive formula.

13. A discrete, edible fat-based flavored food additive as claimed in claim 10 wherein the level of cocoa is between 1 to 10%, by weight.

14. A discrete, edible fat-based flavored food additive as claimed in claim 1 additionally comprising additional flavoring agents selected from the group consisting of cinnamon, ginger, nutmeg, cloves, allspice, maple sugar, dehydrated maple syrup, and mixtures thereof.

15. A discrete, edible fat-based flavored food additive as claimed in claim 1 wherein said sugar is a finely ground sugar.

16. A discrete, edible fat-based flavored food additive as claimed in claim 1 wherein said food additive has a size between 3 to 30 mm.

17. A discrete, edible fat-based flavored food additive as claimed in claim 1 wherein said food additive is molded into the shape of a coffee bean.

18. A process for the production of a discrete, edible fat-based flavored food additive comprising the following steps, namely:
(a) mixing the bakery-compatible oil with finely ground coffee and optionally cocoa in a mixer at a temperature of about 35 degrees C. to about 50 degrees C., so as to obtain an homogenous mixture having the coffee (and cocoa) suspended therein;
(b) transferring the homogenous mixture to a holding tank, and maintaining the temperature of the homogenous mixture at about 39 degrees C. to about 45 degrees C.;
(c) continuously agitating the homogenous mixture while it is in the holding tank;
(d) pumping the homogenous mixture to a tempering unit, continuously agitating the homogenous mixture while in the tempering unit, and slightly cooling the homogenous mixture to about 29 degrees C. to about 34 degrees C.;
(e) transferring the slightly cooled homogenous mixture to a further mixing tank, and mixing sugar therewith;
(f) transferring the resultant sugar, coffee, oil and optionally cocoa mixture to a further discrete particle manufacturing means so as to produce discrete flakes, chips, chunks or molded products, from that resultant mixture;
(g) cooling the discrete flakes, chips, chunks or molded products to a temperature of from about 6 degrees C. to about 12 degrees C.; and
(h) finally, removing the cooled discrete flakes, chips, chunks or molded products for further handling and/or storage and/or shipping.

19. A food product comprising a discrete, edible fat-based flavored food additive wherein said additive has been molded in a mold, formed into chips, or spread onto a belt for manufacture into flake or chunk products; and wherein said flavored food additive comprises from substantially 0% to 5% by weight of moisture, from about 2% to about 35% by weight of a finely ground natural flavoring agent comprising coffee and optionally cocoa, from about 25% to about 35% by weight of a bakery-compatible oil that is substantially liquid at about 35 degrees C. to about 40 degrees C., with the balance being sugar.

20. A food product as claimed in claim 19 wherein said food product is a baked good, or an ice cream product.
